(19) United States
(12) Patent Application Publication
(10) Pub. No.: US 2017/0334344 A1
(43) Pub. Date: Nov. 23, 2017

(54) VEHICLE ROOF RACK SYSTEM

(71) Applicant: Ford Global Technologies, LLC, Dearborn, MI (US)

(72) Inventors: Stuart C. Salter, White Lake, MI (US); James J. Surman, Clinton Township, MI (US); Pietro Buttolo, Dearborn Heights, MI (US); Paul Kenneth Dellock, Northville, MI (US); Harry Lobo, Canton, MI (US)

(73) Assignee: Ford Global Technologies, LLC, Dearborn, MI (US)

(21) Appl. No.: 15/157,971

(22) Filed: May 18, 2016

(51) Int. Cl. B60Q 1/26; B60R 9/04; H04W 4/00; G08B 5/36; G01G 23/36; G01G 23/32; G01G 19/12; H04W 84/18

(52) U.S. Cl. CPC B60Q 1/2661; G01G 23/32; B60R 9/04; G01G 19/12; H04W 4/008; G08B 5/36; G01G 23/36; B60Q 2400/20; B60Q 2900/30; H04W 84/18

(57) ABSTRACT

A vehicle is provided that includes a body defining a roof. A roof rack is operably coupled to the roof through a plurality of mounting features and configured to support cargo. A load cell is positioned on each of the mounting features and configured to sense a load on the roof rack associated with the cargo. A controller is in communication with the load cells and an electronic device and a light source is positioned proximate each of the mounting features. The light source is configured to emit light based on the load sensed by the load cell.

### FIELD OF THE INVENTION

The present disclosure generally relates to vehicle storage systems, and, more particularly, to vehicle roof storage systems employing sensing structures.

### BACKGROUND OF THE INVENTION

Drivers of automotive vehicles often store cargo on a roof of the vehicle in order to save space within the vehicle for occupants. In some instances, the cargo may be too heavy or unbalanced.

### SUMMARY OF THE INVENTION

According to one aspect of the present disclosure, a vehicle is provided that includes a body defining a roof. A roof rack is operably coupled to the roof through a plurality of mounting features and configured to support cargo. A load cell is positioned on each of the mounting features and configured to sense a load on the roof rack associated with the cargo. A controller is in communication with the load cells and an electronic device, and a light source is positioned proximate each of the mounting features. The light source is configured to emit light based on the load sensed by the load cell.

According to another aspect of the present disclosure, a vehicle is provided that includes a body defining a roof. A roof rack is operably coupled to the roof through a mounting feature and configured to support cargo. A load cell is positioned on the mounting feature and configured to sense a load on the roof rack, and a controller is in communication with the load cell and an electronic device. The controller is configured to output a signal to the electronic device indicative of the load placement of the cargo.

According to yet another aspect of the present disclosure, a vehicle is provided that includes a body defining a roof. A roof rack is operably coupled to the roof through a plurality of mounting features and configured to support cargo. A load cell is positioned on the mounting feature and configured to sense a load on the roof rack and a light source is positioned proximate each of the mounting features. The light sources are configured to emit light based on a load sensed by the load cell.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a upper perspective view of a vehicle equipped with a roof rack, according to one embodiment;

FIG. 2 is an enlarged view of a mounting feature of the roof rack, according to one embodiment;

FIG. 3 is a schematic block diagram of the vehicle and the roof rack system, according to one embodiment;

FIG. 4A is a flow chart of a cargo routine, according to one embodiment; and

FIG. 4B is a flow hart of a cargo routine while the vehicle is moving, according to one embodiment.

### DETAILED DESCRIPTION OF THE PREFERRED EMBODIMENTS

Additional features and advantages of the invention will be set forth in the detailed description which follows and will be apparent to those skilled in the art from the description or recognized by practicing the invention as described in the following description together with the claims and appended drawings.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

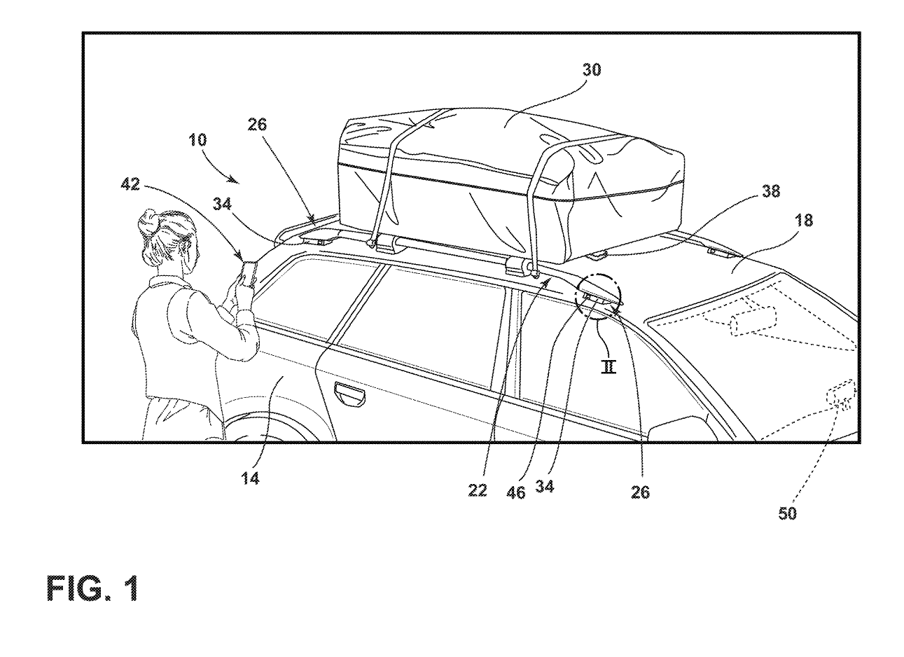

Referring now to FIGS. 1-3, reference numeral 10 generally designates a vehicle. The vehicle 10 includes a body 14 defining a roof 18. A roof rack 22 is operably coupled to the roof 18 through a plurality of mounting features 26 and configured to support cargo 30. A load cell 34 is positioned on each of the mounting features 26 and configured to sense a load on the roof rack 22 associated with the cargo 30. A controller 38 is in communication with the load cells 34 and an electronic device 42. A light source 46 is positioned proximate each of the mounting features 26. The light sources 46 are configured to emit light based on the load sensed by the load cells 34.

Referring now to FIG. 1, positioned within the vehicle 10 is a display 50. The display 50 may be a human machine interface, or infotainment system, with a screen for depicting camera and computer generated images as well as information related to the vehicle 10. The display 50 may be a touch screen and/or be operated by mechanical inputs (e.g., keyboard, mouse, scroll wheel, knob, etc.). The display 50 may be configured to depict an image or show data from the controller 38, as explained in greater detail below. The cargo 30 is positioned and supported on the roof rack 22. In the depicted example, the cargo 30 is luggage, but may be other bulky items such as boxes, mattresses, furniture or the like. The cargo 30 is supported by the roof rack 22 which transfers the weight of the cargo 30 to the roof 18. It will be understood that a plurality of intermediary structures may be positioned between the cargo 30 and the roof rack 22 without departing from the teachings provided herein. The roof rack 22 may be integrally defined by the roof 18 or coupled thereto. In various embodiments, the roof rack 22 may be an aftermarket item or may be provided by the manufacturer. The roof rack 22 is supported by the roof 18 by the plurality of mounting features 26. The roof rack 22 may be supported by the roof 18 at 3, 4, 5, 6, 7, 8, or greater than 8 different points or regions to help distribute the load of the cargo 30.

In various embodiments, the controller 38 is configured to communicate with and detect the location of the electronic device 42. The electronic device 42 may be positioned within the vehicle 10, or external to the vehicle 10, and may include a cellphone, mobile communication device, a key FOB, wearable device (e.g., fitness band, watch, glasses, jewelry, wallet), apparel (e.g., a tee shirt, gloves, shoes or other accessories), personal digital assistant, headphones and/or other devices capable of wireless transmission (e.g., radio frequency, Bluetooth, ultrasonic). As discussed in greater detail below, the controller 38 may transmit information to the electronic device 42 and/or display 50 related to the cargo 30 (e.g., total weight, weight distribution, securement instructions).

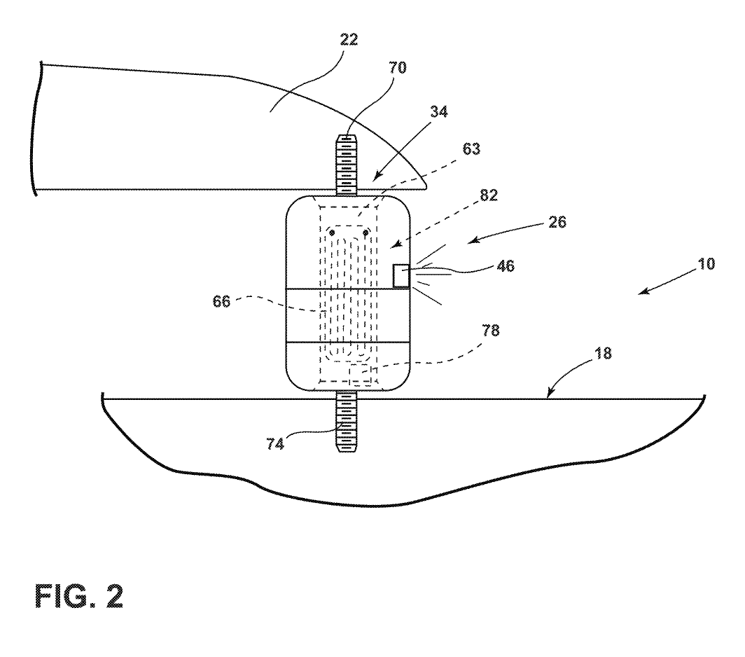

Referring now to FIG. 2, as explained above, the mounting features 26 include the load cells 34. The load cells 34 include a load member 62 and a strain gauge 66. The strain gauge 66, in one example, may include an insulating flexible backing which supports a metallic foil pattern. The load member 62 may be a monolithic piece of polymer, ceramic, or metal. The strain gauge 66 is attached to the load member 62 by a suitable adhesive or other bonding method. As the load member 62 is deformed due to the load of the cargo 30 (FIG. 1), the foil is deformed, causing its electrical resistance to change. This resistance to change, usually measured using a Wheatstone bridge, may be calculated by the controller 38 (FIG. 1) into a load experienced by the load cell 34 of the mounting feature 26. Extending from the load member 62 is a rack feature 70 and a roof feature 74 configured to secure the mounting feature to both the roof rack 22 and the roof 18, respectively. Positioned within the mounting feature 26, and in communication with the strain gauge 66 of the load cell 34, is a wireless communication transceiver 78. The wireless communication transceiver 78 is configured to communicate information about the load on the load cell 34 from the strain gauge 66 to the controller 38, the electronic device 42 and/or the display 50 (FIG. 1). Positioned around the load cell 34 and the wireless communication transceiver 78 is an over-mold 82. The over-mold 82 may be made of a polymeric and/or metallic material and configured to provide a decorative appearance to the mounting features 26 and/or protect the load cell 34 and wireless communication transceiver 78 from environmental exposure.

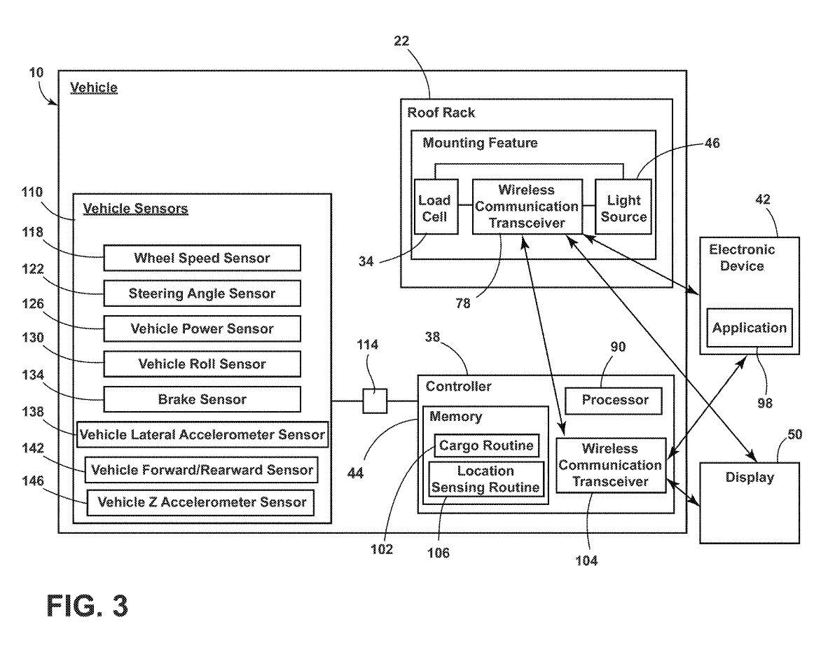

In the depicted embodiment, the light sources 46 are disposed within the over-mold 82 of the mounting feature 26, but may be located proximate the mounting feature 26 in the roof 18 and/or the roof rack 22 without departing from the teachings provided herein. Further, it will be understood that the inclusion of the light sources 46 is optional and that only some, or none, of the mounting features 26 may include the light sources 46. The light sources 46 may include red-green-blue light emitting diodes (LEDs), incandescent lights, or other light sources. The light sources 46 may be in electrical communication with the load cells 34, as depicted in FIG. 3. The light source 46 may be configured to receive a signal from the load cell 34 and/or the wireless communication transceiver 78 which changes the color, intensity, intermittence or other property of the light emitted from the light source 46 based on the weight or load experienced by the load cell 34. For example, in red-green-blue LED embodiments of the light source 46, the light source 46 may emit green light while the weight experienced by the load cell 34 is less than a predetermined threshold (e.g., determined by the operator through the electronic device 42 or the display 50, or the vehicle controller and/or controller 38 of FIG. 1), yellow when the weight experienced by the load cell 34 is approaching the predetermined threshold, and red when the weight experienced by the load cell 34 is greater than the predetermined threshold. Such a feature may be advantageous in that the differing colors of light emitted by the light sources 46 may allow a person positioning the cargo 30 (FIG. 1) to quickly determine if the load placement is uneven (e.g., because some of the light sources 46 will be a different color than others) or if the load cells 34 are over loaded (e.g., by the emission of red light from the light source 46). It will be understood that the light sources 46 may contribute to an aesthetic appearance or safety lighting of the vehicle 10 while not indicating the load status of the load cells 34 and/or that the light sources 46 may terminate the emission of light (i.e., be turned off) after a predefined condition (e.g., after movement of the vehicle 10 or after a predetermined amount of time) occurs.

Referring now to FIG. 3, a block diagram of the vehicle 10 is shown including the roof rack 22. As explained above, the mounting feature 26 may include one or more wireless communication transceivers 78 that are configured to communicate with the electronic device 42 and with the controller 38. The wireless communication transceivers 78 may communicate with the electronic device 42 over a wireless signal (e.g., radio frequency). In specific examples, the wireless communication transceivers 78 may be a Bluetooth™ RN4020 module, or an RN4020 Bluetooth™ low energy PICtail board configured to communicate with the electronic device 42 using Bluetooth™ low energy signals. The wireless communication transceivers 78 may include a transmitter and a receiver to transmit and receive wireless signals (e.g., Bluetooth™ signals) to and from the electronic device 42. It will be appreciated that the wireless communication transceivers 78 may utilize other forms of wireless communication between the electronic device 42 and other wireless communication transceivers 78, such as Wi-Fi™. The wireless communication transceivers 78 may be positioned on or within the controller 38. The controller 38 may be a dedicated controller 38 or may be a shared controller 38 (e.g., for multiple features). The controller 38 may include a processor 90 and a memory 94 for executing stored routines or for storing information (e.g., related to the operation of the load cell 34 and/or the electronic device 42). The wireless communication transceiver 78 is configured to communicate with the processor 90 such that one or more of the routines stored in the memory 94 is activated. The electronic device 42 may include one or more routines which control the communication between the wireless communication transceiver 78 and the electronic device 42. For example, in mobile smart phone embodiments of the electronic device 42, the phone may include one or more applications 98 configured to communicate with the wireless communication transceivers 78. In the depicted embodiment, the memory 94 of the controller 38 includes a cargo routine 102 and a location sensing routine 106. In various embodiments, the controller 38 is a standalone device that is not in communication with body control modules, electronic control modules, engine control modules and/or other features of the vehicle 10. For example, the wireless communication transceivers 78 may only be capable of communication with the load cell 34 and the electronic device 42. In other embodiments, the wireless communication transceivers 78 may communicate with the body controller or other onboard controllers. In the depicted embodiment, the controller 38 is in communication with one or more vehicle sensors 110 that may be used in conjunction with the controller 38 and may communicate with the controller 38 through a multiplex communication bus 114. The vehicle sensors 110 may include a wheel speed sensor 118, a steering angle sensor 122, a vehicle power sensor 126, vehicle roll sensor 130, a brake sensor 134, a vehicle lateral accelerometer 138, vehicle forward/rearward sensor 142, a vehicle Z accelerometer sensor 146, and/or any other sensor that may be disposed within a vehicle 10.

The vehicle 10 may include a plurality of wireless communication transceivers 78, similar to that described in connection with the load cell 34, positioned around the vehicle 10 (e.g., a rear, sides, or front of the vehicle 10, each of the mounting features 26). The wireless communication transceivers 78 may be in communication with one another or may mutually communicate with a master controller or module (e.g., body control module or the controller 38). The wireless communication transceivers 78 may be disposed within other accessories of the vehicle 10, or may be standalone units. The electronic device 42 may communicate with all, some, or none of the wireless communication transceivers 78 as the electronic device 42 enters and exits the communication range of the transceivers 78. Each of the wireless communication transceivers 78 may be aware of its location within the vehicle 10 and capable of sharing its location with the electronic device 42. In various embodiments, the wireless communication transceivers 78 are capable of communicating with the electronic device 42 such that the location of the electronic device 42 may be determined therefrom (e.g., based on signal strength and/or return time of the signal) or vice versa. According to one embodiment, the location sensing routine 106 in the memory 94 of the controller 38 may utilize the signal strength and time to return of the signals between the wireless communication transceivers 78 and the electronic device 42 to triangulate the position of the electronic device 42 as the person moves around and inside of the vehicle 10. In embodiments where the wireless communication transceivers 78 communicate with a master module, the location of the electronic device 42 may be calculated in the master module. The location of the electronic device 42 may have sufficient resolution to determine which seat within the vehicle 10 the user is approaching or sitting in. The electronic device 42 may then share its determined location with the wireless communication transceivers 78 such that appropriate features (e.g., approach lighting or cargo placement suggestions and notifications) may be activated by the appropriate transceivers 78. It will be understood that the location sensing routine 106 may be located on the electronic device 42 and that any location determinations may be made by the electronic device 42 and shared with the wireless communication transceivers 78 without departing from the spirit of this disclosure.

Choosing which electronic devices 42 should be trusted, and, therefore, given access to command of the controller 38, may be determined based on whether the electronic device 42 has been inside of the vehicle 10 before. The memory 94 of the controller 38 may store identifying information relating to the electronic device 42 that were detected within the vehicle 10 (e.g., using the location sensing routine 106) and which may therefore be generally regarded as “friendly” and/or as the owner of the vehicle 10. In an exemplary method of determining that an unknown electronic device 42 is friendly, the wireless communication transceivers 78 detect the presence of an unknown electronic device 42, detect a characteristic signal shift (e.g., attenuation or increase in signal at corresponding wireless communication transceivers 78) indicative of the unknown electronic device 42 entering or being within the vehicle 10 across multiple wireless communication transceivers 78, and store characteristic information about the electronic device 42 for future identification. It will be understood that a determination of the location of the electronic device 42 within the vehicle 10 may also prompt a storing of the characteristic information about the electronic device 42 for future identification. Utilizing the past and/or present location of the electronic device 42 as a security feature to determine if it is allowed access to the controller 38 may be particularly advantageous as the replication of signal shifting indicative of the electronic device 42 entering the vehicle 10, and the location of the electronic device 42, is particularly difficult to fake. Further, it will be understood that more conventional methods of connecting electronic devices 42, such as pairing and manually connecting, may also be utilized to designate friendly devices 42.

Detection of location of the electronic device 42 relative to the vehicle 10 also permits the wireless communication transceivers 78 to determine if an unrecognized electronic device 42 is proximate the vehicle 10. Such an unrecognized electronic device 42 may be owned or carried by a potential burglar or threat to the vehicle 10. For example, an unrecognized electronic device 42 may indicate that someone is attempting to steal the cargo 30 (FIG. 1) or create a hazardous condition. In events where an unrecognized electronic device 42 is detected proximate the vehicle 10 for greater than a predetermined time, the wireless communication transceivers 78 may activate one or more counter measures. Countermeasures may include activation of an alarm (e.g., activation of the lights and horns of the vehicle 10) and/or notifications on a friendly electronic device 42. It will be understood that the countermeasures may also be activated if the load cells 34 detect the movement of the cargo 30 over a predetermined threshold while the vehicle 10 is stationary and a friendly electronic device 42 is not proximate the vehicle 10. In some embodiments, any available identifying information about the potentially hostile electronic device 42 may be stored for later retrieval if the owner of the vehicle's electronic device 42 is not detected proximate the vehicle 10 at the same time. The wireless communication transceivers 78 may store greater than fifty electronic devices 42 that may have been a threat.

Still referring to FIG. 3, the cargo routine 102 may be initialized by activation on the electronic device 42 and/or display 50 (e.g., by opening the application 98 or through another prompt), detection of the electronic device 42 proximate the roof rack 22 for a predetermined period of time and/or through the load cells 34 sensing a load changing (i.e., indicative of the cargo 30 being removed or added) on the roof rack 22. The cargo routine 102 may perform a variety of functions designed to send information to the electronic device 42 and/or the display 50 which is configured to aid a person in loading (e.g., through cargo loading and placement instructions) and securing the cargo 30 (FIG. 1) to the roof rack 22 in real time. The cargo routine 102 may be utilized to provide guidance to a user of the electronic device 42 and/or display 50 on how to secure, load and/or place the cargo 30 to the roof rack 22 (e.g., a video and/or tutorial about how to attach and place the cargo 30 to the roof rack 22) and/or show real time data about the current configuration of the cargo 30 on the roof rack 22.

In embodiments where real time data about the cargo 30 is being shown, the cargo routine 102 may be utilized to output a signal from the controller 38 or the load cells 34 to the electronic device 42 and/or display 50 indicative of the placement of the cargo 30. Such a signal may be utilized by a person to aid in positioning of the cargo 30 on the roof rack 22. For example, the controller 38 may be capable of sending total load measurements, balance of load measurements, change in load balance (e.g., shifting load due to dynamics of the vehicle 10 or due to vibration or buffeting of the cargo 30 due to wind) and/or changes in load with vehicle dynamics due to cargo configuration (e.g., high center of gravity). As explained above, the controller 38 is in communication with the vehicle sensors 110 and/or an accelerometer located within the electronic device 42. Such sensors 110 may be utilized during a test drive procedure (e.g., involving accelerating, braking, turning) to calculate the load dynamics and make suggestions on how to reposition the cargo 30 (e.g., shift the cargo 30 forward, towards the driver side, rearward, or towards the passenger side).

Further, the connection to the sensors 110 permits the controller 38 to predict if the loading of the cargo 30 (e.g., total weight, weight balance, or cargo configuration) will result in excessive stress on the roof rack 22 during maximum deceleration and lateral acceleration (e.g., due to braking and turning) and alert the electronic device 42 or display 50. If an overload or imbalance of the cargo 30 is detected while the vehicle 10 is in motion, a real time warning can be provided to the electronic device 42 and/or display 50 to alert the driver of the vehicle 10 to reduce speed, increase turning radius, use smoother roads, limit acceleration or braking, or to stop and examine the cargo 30. It will be understood that the warning may be a graphical representation or a haptic feedback (e.g., on the electronic device 42, steering wheel, gas or brake pedals, etc.). Further, the memory 94 of the controller 38 may function as a “black box” and record instances where a dangerous static or dynamic load overload, or an unbalanced condition, is detected and transmitted to the electronic device 42 and/or display 50 for use in vehicle accident investigation or for later use.

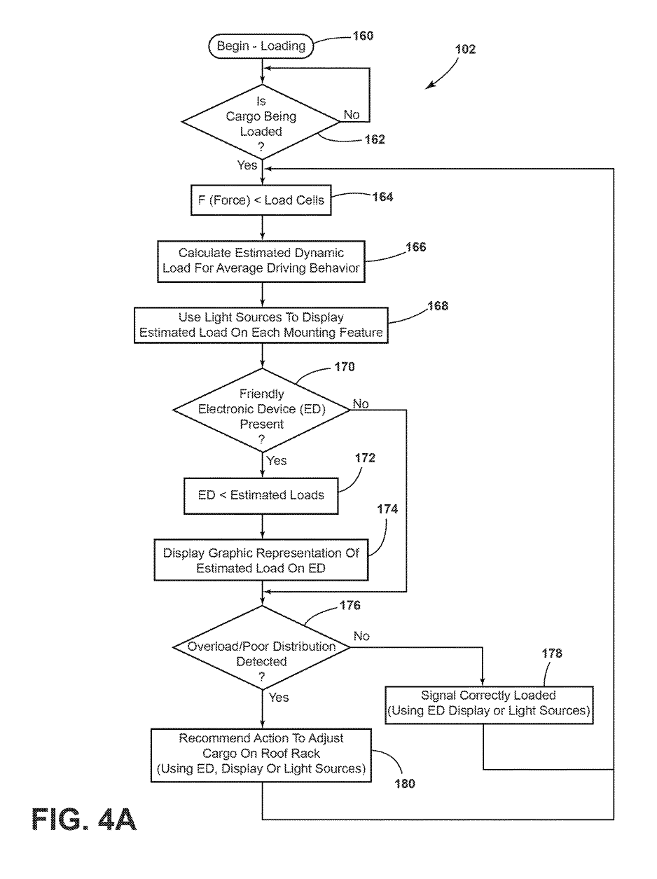

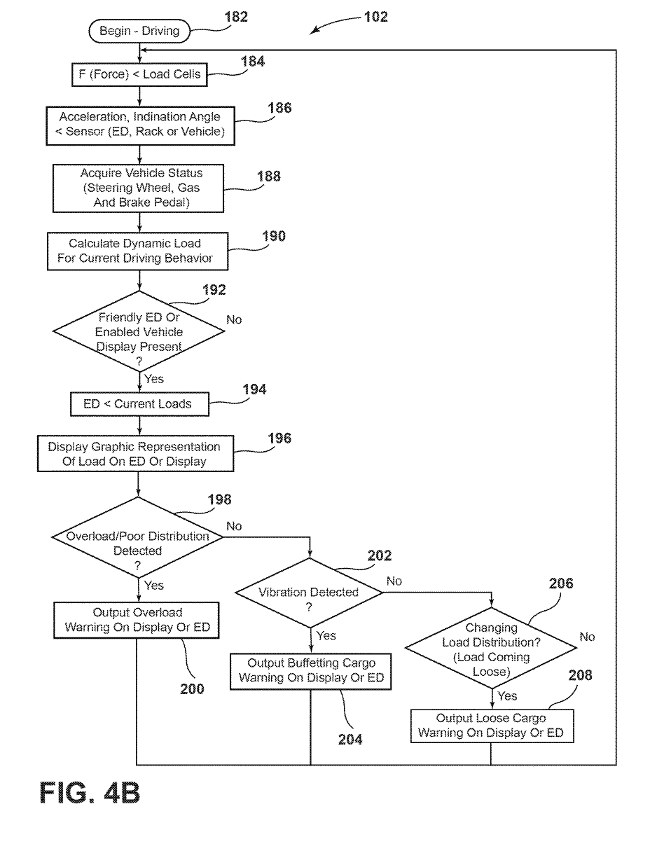

Referring to FIGS. 4A and 4B, embodiments of the cargo routine 102 are depicted showing use of the cargo routine 102 during loading of the vehicle 10 (FIG. 4A) and during driving of the vehicle 10 (FIG. 4B). Referring now to FIG. 4A, in the depicted embodiment, the cargo routine 102 may begin at step 160 when loading of the roof rack 22 is sensed via the load cells 34 or through a prompt on the electronic device 42 and/or display 50. At decision step 162, if the if cargo 30 (FIG. 1) is sensed as being loaded, the routine 102 proceeds to step 164 where the load cells 34 determine a force exhibited by the cargo 30. Next step 166 is performed where a dynamic load of the cargo 30 for average driving behavior is performed. Next step 168 of using the light sources 46 to display an estimated load on each mounting feature 26. Next, a decision is made at step 170 to determine if a friendly designated electronic device 42 is proximate the vehicle 10. If a friendly designated electronic device 42 is proximate the vehicle 10, the routine 102 proceeds to step 172 of transmitting the estimated dynamic load to the electronic device 42. Next, step 174 of displaying a graphic representation of the estimated load on the electronic device 42 is performed. Next decision 176 determines if there is an overload of the cargo 30 or poor distribution of the cargo 30 is detected. If there is no detected overload or poor distribution of the cargo 30 detected, step 178 is performed which signals that the cargo is correctly loaded using the electronic device 42 and/or the display 50. If in decision 176, an overload or poor load distribution is detected, the routine 102 may proceed to step 180 of recommending action to adjust cargo 30 on the rack 22. The routine 102 may then return to step 164.

Referring now to FIG. 4B, as explained above, the cargo routine 102 may also be used during a test drive or during driving of the vehicle 10. In the depicted embodiment, the cargo routine 102 begins in step 182 with driving of the vehicle 10. Next, step 184, which is substantially similar to step 164, is performed where the load cells 34 determine a force exhibited by the cargo 30. Next, step 184 is performed which utilizes the vehicle sensors 110 and/or sensors on the electronic device 42. Step 184 determines the acceleration and inclination of the vehicle 10 based on the readings from the 110 and/or sensors on the electronic device 42. Next, step 188 is performed which acquires the status of the vehicle 10 (e.g., accelerating, braking, etc.) using the vehicle sensors 110. Next, step 190 of calculating a dynamic load of the cargo 30 for the current driving conditions (e.g., the vehicle status of step 188) is performed. Next, a decision is performed at step 192 of determining if a friendly electronic device 42 or the display 50 is present or proximate the vehicle 10. If yes, step 194 is performed which transmits the current calculated loads of the cargo 30 from the load cells 34 is transmitted to the electronic device 42. Next, step 196 of displaying a graphic representation of the load on the electronic device 42 or display 50 is performed. Next, a decision is made at step 198 of determining if an overload of the roof rack 22 or poor distribution of the cargo 30 is present. If yes, step 200 is performed which outputs an overload or poor distribution load warning to the display 50 or the electronic device 42. If the answer is no to step 198, a decision is made at step 202 of determining if vibration or buffeting of the cargo 30 is detected. If yes, step 204 of outputting a cargo buffeting warning is output to the display 50 or electronic device 42. If no, the routine 102 moves to a decision at step 206 which determines if there is a changing load distribution of the cargo 30 (e.g., indicative of the cargo coming loose) present. If yes, the routine 102 moves to step 208 which outputs a loose cargo warning on the display 50 or electronic device 42. The routine 102 may then return to step 184.

A variety of advantages may be derived from use of the present disclosure. First, use of the load cells 34 allows for the measurement of static and dynamic load/balance of the cargo 30 versus the recommended and actual loading capability of the roof rack 22. For example, the controller 38 may link with the automatic brake sensor 134 and the steering angle sensor 122 to get deceleration and turning radius data which may be used to then predict if the roof rack strain would be exceeded at maximum possible vehicle speed, braking and turning. Second, because the load cells 34 and/or controller 38 transmit load information/warnings in real time to the display 50 and/or the electronic device 42, a driver of the vehicle 10 can immediately be made aware of the total load of the cargo 30, suggestions on how to improve load balance, oscillation of load which indicates shifting of the load or the load coming loose, or suggested driving dynamics changes (e.g., slow down, slower turns, limit acceleration, use smoother roads, etc.). It will be understood that warnings can be generated in the steering wheel via EPAS or in the brake pedal via ABS.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims as set forth below, are incorporated into and constitute part of this Detailed Description.

What is claimed is:

1. A vehicle comprising:
a body defining a roof;
a roof rack operably coupled to the roof through a plurality of mounting features and configured to support cargo;
a load cell positioned on each of the mounting features and configured to sense a load on the roof rack associated with the cargo;
a controller in communication with the load cells and an electronic device; and
a light source positioned proximate each of the mounting features, the light source configured to emit light based on the load sensed by the load cell.

2. The vehicle of claim 1, wherein the electronic device is located external to the vehicle.

3. The vehicle of claim 1, wherein the controller is configured to output a signal to the electronic device indicative of the placement of the cargo.

4. The vehicle of claim 3, further comprising:
a display positioned within the vehicle, wherein the controller is configured to output the signal to the display indicative of the placement of the cargo.

5. The vehicle of claim 1, further comprising:
a wireless transceiver positioned within the mounting feature.

6. The vehicle of claim 1, wherein the controller communicates with the electronic device in real time.

7. The vehicle of claim 1, wherein the controller is configured to store information about the electronic device.

8. A vehicle comprising:
a body defining a roof;
a roof rack operably coupled to the roof through a mounting feature and configured to support cargo;
a load cell positioned on the mounting feature and configured to sense a load on the roof rack; and
a controller in communication with the load cell and an electronic device, the controller configured to output a signal to the electronic device indicative of the load placement of the cargo.

9. The vehicle of claim 8, wherein the electronic device is positioned external to the vehicle.

10. The vehicle of claim 9, wherein the controller is in communication with an accelerometer within the electronic device.

11. The vehicle of claim 8, wherein the controller is configured to communicate cargo placement suggestions to the electronic device.

12. The vehicle of claim 8, wherein the controller is configured to communicate cargo loading instructions to the electronic device.

13. The vehicle of claim 8, wherein the controller is in electrical communication with at least one of an automatic brake sensor, a steering wheel angle sensor and a vehicle accelerometer.

14. The vehicle of claim 8, further comprising:
a light source in communication with the load cell and configured to emit light indicative of the loading of the load cell.

15. A vehicle comprising:
a body defining a roof;
a roof rack operably coupled to the roof through a plurality of mounting features and configured to support cargo;
a load cell positioned on the mounting feature and configured to sense a load on the roof rack; and
a light source positioned proximate each of the mounting features, the light source configured to emit light based on a load sensed by the load cell.

16. The vehicle of claim 15, wherein the light source comprises a red-green-blue light emitting diode.

17. The vehicle of claim 16, wherein the light source is configured to be turned off after a predefined condition occurs.

18. The vehicle of claim 17, further comprising:
a controller in communication with the load cell and an electronic device, the controller configured to output a signal to the electronic device indicative of the placement of the cargo.

19. The vehicle of claim 18, wherein the electronic device is a mobile communication device.

20. The vehicle of claim 19, wherein communication of the electronic device is performed using a Bluetooth low energy transceiver disposed within the mounting feature.
